(19) United States
(12) Patent Application Publication
(10) Pub. No.: US 2016/0272501 A1
(43) Pub. Date: Sep. 22, 2016

(54) METHOD FOR PRODUCING FLAKE GRAPHENE BY DIRECT EXFOLIATION OF GRAPHITE

(71) Applicant: INSTYTUT TECHNOLOGII MATERIALOW ELEKTRONICZNYCH, Warszawa (PL)

(72) Inventors: Ludwika LIPINSKA, Warszawa (PL); Magdalena AKSIENIONEK, Warszawa (PL); Michal LEPECKI, Kozienice (PL); Andrzej MARCJANIUK, Warszawa (PL); Michal WOLUNTARSKI, Warszawa (PL); Slawomir CENDROWSKI, Warszawa (PL)

(21) Appl. No.: 14/392,121

(22) PCT Filed: May 29, 2015
(86) PCT No.: PCT/EP2015/061987

§ 371 Date: Dec. 23, 2015

(30) Foreign Application Priority Data
May 30, 2014 (PL) 408377

(51) Int. Cl. C01B 31/04

(52) U.S. Cl. CPC C01B 31/0469

(57) ABSTRACT

The invention is related to a method for producing flake graphene by direct exfoliation of graphite, characterised in that it comprises the following steps: a) an aqueous suspension of graphite with addition of one or more surface active agents is prepared; b) the suspension is frozen; c) the suspension is dried, thereby obtaining flake graphene.

The object of the invention is a method for producing flake graphene. More particularly, the invention relates to a method for producing flake graphene by direct exfoliation of graphite in solutions, especially in aqueous solutions. The graphite used in the method can be synthetic, natural flake, intercalated, heat- or microwave-expanded graphite.

Graphene flakes obtained by the method of direct exfoliation of graphite in solutions have a crystal structure with a low defect density on the flake surface, which results in high electrical conductivity and good mechanical properties [1]. Due to the said advantages, it has a lot of potential applications. Its mechanical properties and the fact that it is much lighter than steel make it very attractive for automotive and aerospace industries, by creating opportunities to reduce mass of vehicles and airplanes. This will allow for the use of smaller amounts of fuel and reduction of pollutants emitted into the atmosphere. Due to its electrical properties, graphene obtained by direct exfoliation of graphite in solutions can be applied in electronics (e.g. conductive inks and pastes [2]), optoelectronics [3], it can also be an excellent material for electrodes in supercapacitors and lithium-ion batteries.

Sizes of graphene flakes obtained by direct exfoliation of graphite in solutions can vary from a few to several hundred microns. Such a large range of sizes is closely correlated with the size of graphite flakes before the process of sonication, which constitute a precursor of graphene flakes, as a final product. The method of direct exfoliation of graphite in solutions allows obtaining flakes with a single layer to a few or a dozen layers depending on the process conditions.

Graphene flakes by direct exfoliation of graphite in solutions were first obtained in 2008 by a group from Manchester University, the solvent used was dimethylformamide (DMF), exfoliation of graphite was supported by ultrasounds [4]. In the same year, a group from Ireland, Trinity College Dublin, conducted successful attempts with other solvents, among others with the much less toxic N-methyl-2-pyrrolidone (NMP) [5]. Unfortunately, the efficiency of these methods is very low, a concentration of the suspension of graphene flakes of the order of 0.1-1 mg/ml is obtained, which, with high costs of reagents, makes it very expensive. Another drawback is the difficulty in processing the suspensions of graphene flakes, dispersed in organic solvents to a powder. Since 2008, intensive efforts to increase the efficiency of the method of direct exfoliation in solutions [6,7] have been made. Other solvents used were, e.g.: benzene, hexafluorobenzene [8] or ionic liquids [9]. Attempts to obtain graphene by a solvent exchange method [10] and with the use of solubilisers [11] have been also made.

An ecological approach assumes avoidance of highly toxic chemicals, such as the above-mentioned NMP, DMF, benzene, therefore attempts towards the use of cheap, safe and commercially available solvents, such as water or ethanol [12,13] and aqueous solutions with addition of surface active agents [14], have been also made. However, previous efforts by numerous research centres have not produced any breakthrough in the exfoliation of graphite in solutions with the use of ultrasound energy [15].

Therefore, other strategies have been also used, e.g.: obtaining graphene by means of CO₂ being in a supercritical state [16] or a technique that uses a pulsed laser [17]. Unfortunately, they require the use of special equipment or installations, and the efficiency of these processes is not impressive either.

Therefore, there is a need to develop a cheap and efficient method for producing flake graphene with the use of safe and commercially available solvents such as water.

The idea behind the invention being applied is the use of anomalous thermal expansion of water which increases its volume during freezing. This phenomenon allows for the use of aqueous solutions for effective intercalation of graphite. To allow water molecules to penetrate between layers of carbon, a compound which lowers surface tension is added, thereby ensuring an excellent wettability of graphite. The use of mild ultrasounds (ultrasonic bath) also helps in wetting the graphite. There are not any literature reports on the use of this strategy in the exfoliation of graphite.

Numbers enclosed in square brackets below refer to the following publications of the prior art:

[1] Athanasios B. et al., Liquid-Phase Exfoliation of Graphite Towards Solubilized Graphenes, Small 5(16) (2009) 1841.

[2] Han X. et al, Scalable, printable, surfactant-free graphene ink directly from graphite, Nanotechnology 24 (2013) 205304.

[3] Zhipei S. et al, Graphene Mode-Locked Ultrafast Laser, ACS Nano 4(2) (2010) 803.

[4] Blake P. et al, Graphene-Based Liquid Crystal Device, Nano Letters 8 (6) (2008) 1704.

[5] Hernandez Y. et al, High-yield production of graphene by liquid-phase exfoliation of graphite, Nature Nanotechnology 3(9) (2008) 563.

[6] Longxiu Z. et al, High-quality production of graphene by liquid-phase exfoliation of expanded graphite, Materials Chemistry and Physics 137 (2013) 984.

[7] Dhakate S. R. et al, An approach to produce single and double layer graphene from re-exfoliation of expanded graphite, Carbon 49 (2011) 1946.

[8] Oyer A. J. et al., Stabilization of graphene sheets by structured benzene/hexafliorobenzene mixed solvent, JACS 134 (2012) 5018.

[9] Sutto T. E. et al, X-ray diffraction studies of electrochemical graphite intercalation compounds of ionic liquids, Electrochimica Acta 54 (2009) 5648.

[10] X. Zhang et al; Dispersion of graphene in ethanol using a simple solvent exchange method; Chem. Comm. 46 (2010) 7539-7541;

[11]. A. B. Bourlinos et al; Liquid-phase exfoliation of graphite towards solubilized graphenes; Small: Nano Micro 16 (2009) 1841-1845;

[12] Yi M. et al, A mixed-solvent strategy for facile and green preparation of graphene by liquid-phase exfoliation of graphite, Journal of Nanoparticle Research 14 (2012) 1003.

[13] Liu W.-W. et al, Exfoliation and dispersion of graphene in ethanol-water mixtures, Frontiers of Materials Science 6(2) (2012) 176.

[14] Sajini Vadukumpully et al, Cationic surfactant mediated exfoliation of graphite into graphene flakes, Carbon 47(14) (2009) 3288.

[15] Wecheng Du et al., From graphite to graphene: direct liquid-phase exfoliation of graphite to produce single- and few-layered pristine graphene, Journal of Materials Chemistry A, 1 (2013) 10592.

[16]. N. W. Pu, C. A. Wang, Y. Sung, Y. M. Liu, M. D. Ger; “Production of few-layer grapheme by supercritical CO₂ exfoliation of graphite”; Mat. Lett. 63 (2009) 1987-1989;

[17]. M. Qian, Y. S. Zhou, Y. Gao, T. Feng, Z. Sun, L. Jiang, Y. F. Lu; “Production of few-layer grapheme through liquid-phase pulsed laser exfoliation of highly ordered pyrolytic graphite”; App. Surf. Sc. 258 (2012) 9092-9095.

According to the Invention, the method for producing flake graphene by direct exfoliation of graphite is characterised in that it comprises the following steps:
a) an aqueous suspension of graphite with addition of one or more surface active agents is prepared;
b) the suspension is frozen;
c) the suspension is dried, thereby obtaining flake graphene.

Preferably, in step a), a suspension of graphite in water at a concentration of 1 g/l to 5 g/l is prepared.

Preferably, in step a), preparation of the mixture is supported by ultrasounds, in particular with the use of an ultrasonic probe or ultrasonic bath.

Preferably, in step b), freezing is carried out using one or more of the following means: freezing equipment (freezer), cryogenic freezing, liquid nitrogen, liquid helium, dry ice.

Preferably, in step c), drying is carried out using one or more of the following means: by sublimation, by spraying, in an evaporator, in a dryer, preferably in the temperature range of 80-100° C., and more preferably at 90° C., in a vacuum dryer, preferably in the temperature range of 80-100° C., and more preferably at 90° C.

Preferably, step c) of drying is carried out immediately after step b) of freezing, especially freezing with liquid nitrogen or liquid helium.

Preferably, step c) of drying is carried out after prior melting of the frozen mixture.

Preferably, step c) of drying is carried out by spraying or in an evaporator.

Preferably, the suspension frozen in step b) is melted and treated with ultrasounds.

Preferably, the suspension is melted and frozen again, possibly with the freezing and melting being repeated many times.

Preferably, before step a), graphite is pre-prepared by intercalation with acids and by heat- and microwave-expansion, possibly with these preparatory processes being carried out several times.

To sum up, in the method for producing flake graphene according to the invention, graphene flakes trapped in graphite's structure are separated from each other by ice crystals during freezing. In the first place, graphite should be soaked in water with addition of one or more surface active agents, facilitating wetting of graphite flakes which have a highly hydrophobic character. Soaking can be supported by ultrasounds. The aqueous suspension with graphite flakes is placed in a container in a freezer. Water which has penetrated into the spaces between carbon plates crystallises under the influence of low temperature and separates successive the carbon layers. The frozen suspension can be melted and dried or dried directly by sublimation. Natural or synthetic graphite, with large or small flakes, can be used in the process. Appropriate pre-preparation of graphite by intercalation with acids and by heat- and microwave-expansion (initial separation of carbon layers in the graphite) is preferable. The preparatory processes can be carried out several times. The processes of freezing/melting of the graphite suspension can be carried out many times.

### PREFERRED EMBODIMENTS OF THE INVENTION

The invention will be presented in greater detail in preferred embodiments, with reference to the accompanying drawings:

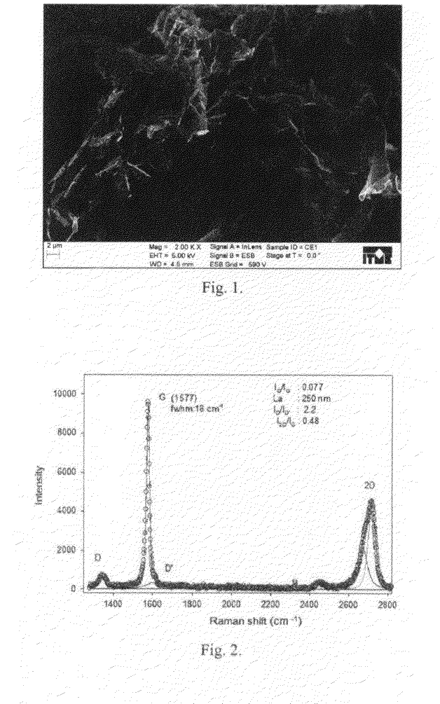

FIG. 1 shows a scanning microscope image of graphene flakes obtained according to Example I;

FIG. 2 shows a Raman spectrum of graphene flakes obtained according to Example II;

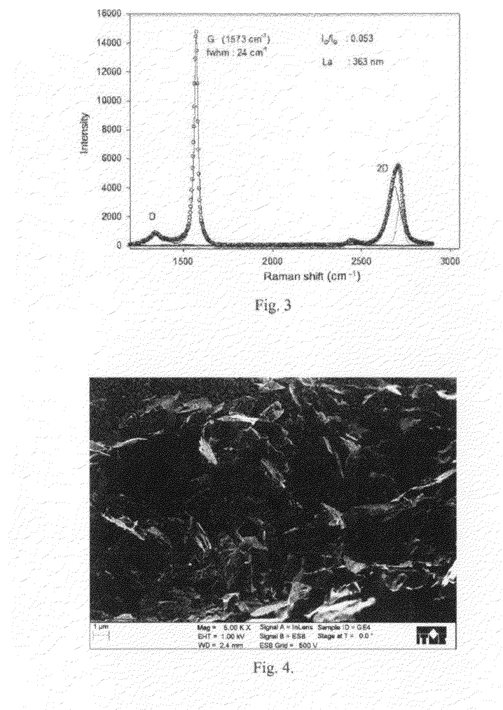

FIG. 3 shows a Raman spectrum of graphene flakes obtained according to Example III;

FIG. 4 shows a scanning microscope image of graphene flakes obtained according to Example IV;

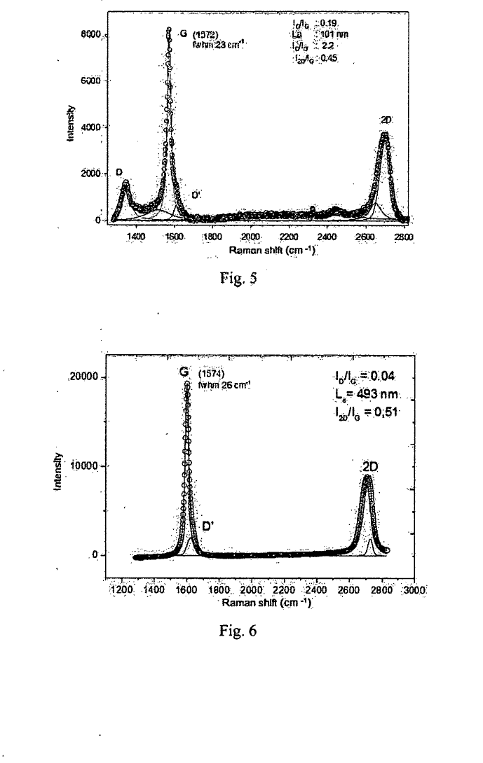

FIG. 5 shows a Raman spectrum of graphene flakes obtained according to Example V;

FIG. 6 shows a Raman spectrum of graphene flakes obtained according to Example VI.

### EXAMPLE I

Natural flake graphite with large flakes was intercalated with acids (sulfuric and nitric acids, and with the ratio of 4:1) and subjected to heat treatment in an oven at the temperature of 1000° C. for the time of 30 sec. During the process, the graphite was expanded. Then, the so prepared graphite was intercalated again and expanded under identical conditions. At the next stage, the graphite was soaked in water (1 g of graphite per 200 ml of H₂O) with a surface active agent (fluorinated alcohol substituted glycol) in the amount of 0.2 ml. Soaking lasted 24-48h at the temperature of 50° C. After this time, the suspension was placed in an ultrasound bath at the temperature of 50° C. and with the power of 750 W for the time of 45 min. Then, the suspension was frozen in a freezer and dried by sublimation in a freeze dryer. (lyophiliser) 1 g of graphene flakes was obtained. A microscopic image of the obtained flakes is shown in FIG. 1.

### EXAMPLE II

Natural flake graphite with large flakes was intercalated with acids (sulfuric and nitric acids, and with the ratio of 4:1) and subjected to heat treatment in an oven at the temperature of 1000° C. for the time of 30 sec. This operation was repeated still three times. At the next stage, the graphite was soaked in water (1 g of graphite per 200 ml of H₂O) with a surface active agent (fluorinated alcohol substituted glycol) in the amount of 0.2 ml. Soaking lasted 24-48h at the temperature of 50° C. After this time, the suspension was placed in an ultrasound bath at the temperature of 50° C. and with the power of 750 W for the time of 45 min. Then, the suspension was frozen in a freezer and dried by sublimation in a freeze dryer. 1 g of graphene flakes was obtained. A Raman spectrum of the obtained flakes is shown in FIG. 2.

### EXAMPLE III

Natural flake graphite with small flakes was intercalated with acids (sulfuric and nitric acids, and with the ratio of 4:1) and subjected to heat treatment in an oven at the temperature of 1000° C. for the time of 30 sec. During the process, the graphite was expanded. Then, the so prepared graphite was intercalated again and expanded under identical conditions. At the next stage, the graphite was soaked in water (1 g of graphite per 200 ml of H₂O) with a surface active agent (fluorinated alcohol substituted glycol) in the amount of 0.2 ml. Soaking lasted 24-48h at the temperature of 50° C. After this time, the suspension was placed in an ultrasound washer at the temperature of 50° C. and with the power of 750 W for the time of 45 min. Then, the suspension was frozen in a freezer and dried by sublimation in a freeze dryer. 1 g of graphene flakes was obtained. A Raman spectrum of the obtained flakes is shown in FIG. 3.

### EXAMPLE IV

Natural flake graphite with small flakes was intercalated with acids (sulfuric and nitric acids, and with the ratio of 4:1) and subjected to heat treatment in an oven at the temperature of 1000° C. for the time of 30 sec. During the process, the graphite was expanded. Then, the so prepared graphite was intercalated again and expanded under identical conditions. At the next stage, the graphite was soaked in water (1 g of graphite per 200 ml of H₂O) with a surface active agent (fluorinated alcohol substituted glycol) in the amount of 0.2 ml. Soaking lasted 24-48h at the temperature of 50° C. After this time, the suspension was placed in an ultrasound bath at the temperature of 50° C. and with the power of 750 W for the time of 45 min. Then, the suspension was frozen in a freezer and melted, followed by drying in an oven at the temperature of 90° C. 1 g of graphene flakes was obtained. A microscopic image of the obtained flakes is shown in FIG. 4.

### EXAMPLE V

Natural flake graphite with very small flakes was intercalated with acids (sulfuric and nitric acids, and with the ratio of 4:1) and subjected to heat treatment in an oven at the temperature of 1000° C. for the time of 30 sec. During the process, the graphite was expanded. Then, the so prepared graphite was intercalated again and expanded under identical conditions. At the next stage, the graphite was soaked in water (1 g of graphite per 200 ml of H₂O) with a surface active agent (fluorinated alcohol substituted glycol) in the amount of 0.2 ml. Soaking lasted 24-48h at the temperature of 50° C. After this time, the suspension was placed in an ultrasound bath at the temperature of 50° C. and with the power of 750 W for the time of 45 min. Then, the suspension was frozen in a freezer and dried by sublimation in a freeze dryer. 1 g of graphene flakes was obtained. A Raman spectrum of the obtained flakes is shown in FIG. 5.

### EXAMPLE VI

Natural flake graphite with large flakes was intercalated with acids (sulfuric and nitric acids, and with the ratio of 4:1) and subjected to heat treatment in an oven at the temperature of 1000° C. for the time of 30 sec. During the process, the graphite was expanded. Then, the so prepared graphite was intercalated again and expanded under identical conditions. At the next stage, the graphite was soaked in a mixture of sulfuric and nitric acids with the ratio of 4:1 (1 g of graphite per 200 ml of the acid mixture). Soaking lasted 20 h at the temperature of 80° C. After this time, the suspension was placed in an ultrasound bath at the temperature of 60° C. and with the power of 750 W for the time of 40 min. Then, the suspension was washed off with deionised water to pH=4.5 and was mixed for additional 24 h at the temperature of 50° C.; was frozen in a freezer and was dried by sublimation in a freeze dryer. 1 g of graphene flakes was obtained. A Raman spectrum of the obtained flakes is shown in FIG. 6.

1. A method for producing flake graphene by direct exfoliation of flake graphite, the method comprising the steps of:
a) an aqueous suspension of graphite with addition of one or more surface active agents is prepared, thereby allowing water molecules to penetrate the graphite layers;
b) the suspension is frozen, thereby expanding the volume of water between the graphite layers;
c) the suspension is dried, thereby obtaining flake graphene.

2. The method according to claim 1, wherein in the step a), a suspension of graphite in water at a concentration of 1 g/l to 5 g/l is prepared.

3. The method according to claim 1, wherein in the step a), preparation of the mixture is supported by ultrasounds, in particular with the use of an ultrasonic probe or ultrasonic bath.

4. The method according to wherein in the step b), freezing is carried out using one or more of the following means: freezing equipment (freezer), cryogenic freezing, liquid nitrogen, liquid helium, dry ice.

5. The method according to claim 1, wherein in the step c), drying is carried out using one or more of the following means: by sublimation, by spraying, in an evaporator, in a dryer, preferably in the temperature range of 80-100° C., and more preferably at 90° C., in a vacuum dryer, preferably in the temperature range of 80-100° C., and more preferably at 90° C.

6. The method according to claim 1, wherein the step c) of drying is carried out immediately after the step b) of freezing, especially if freezing is performed with liquid nitrogen or liquid helium.

7. The method according to claim 5, wherein the step c) of drying is carried out after prior melting of the frozen mixture.

8. The method according to claim 7, wherein the step c) of drying is carried out by spraying or in an evaporator.

9. The method according to claim 1, wherein the suspension frozen in step b) is melted and treated with ultrasounds.

10. The method according to claim 9, wherein the suspension is melted and froze again, possibly with the freezing and melting being repeated many times.

11. The method according to claim 1, wherein before performing the step a), graphite is pre-prepared by intercalation with acids and by heat- and microwave-expansion, possibly with these preparatory processes being carried out several times.
